(19) United States
(12) Patent Application Publication
(10) Pub. No.: US 2010/0094672 A1
(43) Pub. Date: Apr. 15, 2010

(54) Equation to monitor the economic vitality of nations and other social systems

(76) Inventor: Mark H. Macy, Louisville, CO (US)

Correspondence Address: Mark H. Macy, 1021 Willow Place, Louisville, CO, 80027, US

(21) Appl. No.: 12/287,875

(22) Filed: Oct. 15, 2008

(51) Int. Cl. G06Q 10/00; G06Q 50/00

(52) U.S. Cl. 705/7

(57) ABSTRACT

This invention is a ratio (or equation) to monitor the economic well-being of nations and other social systems: V=R:N (economic vitality M is determined by the natural resources [R] available to a social system, in relation to the system's resource needs [N]). With clear and specific definitions of products, natural resources, social systems, and other related terms that make said ratio viable, said ratio can be programmed into a system-wide computer network, accepting input relating to needs and resources from throughout the system and issuing an alert in the event of a negative ratio (a condition in which needs for any specific resource exceed the system's access to that resource).

### BACKGROUND OF THE INVENTION

1. Field of the Invention

I, Mark H. Macy, have invented a new equation or ratio to monitor the economic condition of a social system, especially a nation.

### OBJECTS AND SUMMARY OF THE INVENTION

It is an object of this invention to provide a ratio to help ensure the economic stability and well-being of nations (and other social systems).

It is a further object of this invention to provide a ratio that is simple and easy to program into a computer network in order to monitor the variables inherent in the ratio, in such a way that the system issues alerts (e.g. emails, reports, printouts . . . ) whenever the program detects economic conditions begin to destabilize.

It is a further object of this invention to provide a new set of five classifications of terrestrial living systems (biosystems, bio-subsystems, ecosystems, ordisystems, and social systems) and concise definitions for those five terms as well as definitions for “living system,” “products,” and “natural resources,” which altogether make the ratio viable. This, then, is the ratio:

Economic Vitality=Natural Resources Social System Needs

or

V=R:N

### DETAILED DESCRIPTION OF THE INVENTION

The Vitality Ratio (V=R:N) is viable only in conjunction with certain new classifications and definitions, described below:

### 1. Five Classifications of Living Systems

There are countless varieties of living systems in our world that can be classified in various ways. The following way involves just five basic groups determined by how orderly life is within them and around them:

Biosystems are the somewhat independent plants and animals of Earth (birds, trees, people, cats, frogs . . . ), as well as bacteria, viruses, and other organisms of all sizes. Things are very well-organized inside a biosystem but more or less chaotic outside, depending on whether it inhabits an ecosystem, a social system, or an ordisystem.

Bio-subsystems are the inner parts of biosystems, such as a heart within a person, or a heart cell within a heart, or tiny organelles within a heart cell. Life is very well-organized both inside and outside a bio-subsystem, which can't survive on its own and is “locked in” to its host system.

Ecosystems (forests, oceans, jungles, savannahs . . . ) are the wild places whose members (biosystems, social systems, and ordisystems) fight and kill each other for nourishment, territory, and defense. Ecosystems are rife with conflict and disorder inside and out.

Ordisystems (honeybee hives, ant colonies, and termite colonies, for example) are tightly knit communities of biosystems living together compatibly within a protective enclosure, with the clear understanding that the needs of the community outweigh the needs of individual members.

Social systems are human groups ranging in size from families and friendships to nations and religions. Social systems aren't as tightly knit as biosystems or ordisystems, in which the needs of the group clearly outweigh the needs of individual members. Considering the many forms of government with their different policies for or against freedom and/or equality (autocratic, democratic, socialistic, and so on) it is apparent that humankind struggles perpetually to find a balance between the needs of individual human beings to be free and the needs of their groups to be stable.

If we could step back and observe all the life forms on Earth, we'd see that most but not all fit neatly into these five groupings. Some seem to be hybrids. Or, stated differently, the five groupings don't have a solid line between them; they sort of blend together as in the following table, in which white is at the orderly end of the spectrum, and dark is at the chaotic end.

| Types of Life | |
|---|---|
| Forms | Examples and descriptions |
| Bio-Subsystems | Organs, body cells, and organelles are orderly inside, as well as outside in the cozy and |
| | complex, tightly organized world around them. |
| (hybrid example) | E. coli bacteria in the human gut are parasites (biosystems), but they behave like natural |
| | parts of us (bio-subsystems), helping us to digest the food we eat. |
| Biosystems | People, trees, cats, bees, and bacteria are orderly inside, but more or less chaotic outside |
| | in their surrounding ecosystems, social systems and ordisystems. |
| (hybrid example) | The Portuguese man o' war looks like a jellyfish (biosystem), but it's actually a colony |
| | (ordisystem) composed of four kinds of specialized polyps living together tightly within the |
| | confines of the organism. The polyps can't survive on their own; one polyp digests food |
| | for the colony, another procreates, and so on. The colony is so well-integrated that it |
| | behaves like a crude biosystem, floating with the current (unable to swim), but stinging |
| | and eating fish that swim into its tentacles. |
| Ordisystems | Bee hives and ant colonies are organized inside, but not outside in the surrounding eco- |
| | system. |
| 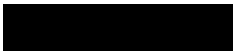 | Military boot camp, formal meetings, religious ceremonies, some communist-totalitarian societies, and other social systems with rituals, tight regulation, and specialized roles are sometimes so regimented that they're compared to insect colonies. |
| 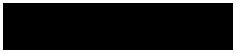 | Families, companies, and nations are typical social systems-subject not only to their members' noble side (wisdom, empathy, honesty, trust . . .), but also to their fears, envy, resentments, and other savage moods, which stir conflicts and tensions within the group as well as with other social systems, so the typical social system rarely becomes as or- derly as a bio system or ordisystem. |
| 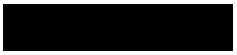 | Run-down neighborhoods of gangs, drug dealers, pawn shops, porn shops, and liquor stores inspire the phrase, “It's a jungle out there,” because of the violence, desperation, and predation among the people. |
| 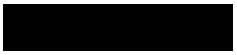 | Jungles, forests, coral reefs, savannahs . . . . Chaos and conflict are the rule, as living systems in the ecosystem kill and eat each other to survive. |

So this is one easy way to classify the myriad living systems on Earth—by how orderly or disorderly things are inside and outside the system—and it helps set the ground work for a more natural form of economics that can make the Vitality Ratio viable.

### 2. Life's Nested Structure

Life on Earth is a chain of nested systems (that is, systems within systems within systems . . . ). Looking inside a biosystem like the human body we find several large bio-subsystems, including nervous system, circulatory system, and digestive system. Each major bio-subsystem, in turn, is composed of smaller bio-subsystems—organs, glands, tissues . . . which are composed of cells . . . downward . . . inward . . . .

Looking outside the human body, we are part of several social systems, including perhaps family, company, church (or mosque or temple or synagogue), clubs, professional organizations, and friendships. These in turn may compose larger and larger social systems. Family, for example, is part of a neighborhood, which might be part of a city, which is part of a state or province, which is part of a nation, which is a member of international alliances . . . upward . . . outward . . . .

The human being, then, like any other living system on Earth, is one link in a nested chain of living systems, which for us humans include body cell within organ within person within family within city within nation. But that complex condition does not lend itself easily to computer analysis, so we must simplify, as described below.

### 3. Basic Building Blocks

Although life on Earth is a vast array of nested systems, it helps to understand living systems as being composed of basic building blocks. This is a simpler, more practical view of life, and it is also accurate, since all of the chains of nested life within a living system do come together in those “basic building blocks.” Some examples:

A biosystem example: The basic building blocks of a human being are body cells (bone cells, muscle cells, blood cells, nerve cells . . . ) and molecules (hormones, enzymes, DNA . . . ). The body cells work together and use the molecules to keep the complete system alive and healthy.

An ordisystem example: The basic building blocks of a honeybee hive are the bees themselves and their products (honey, royal jelly, honeycombs . . . ). The bees work together and use the products to keep the colony alive and healthy.

A social system example: The basic building blocks of a nation are people and products (houses, clothes, foodstuffs, cattle, highways, pets, computers, TVs, ships, stores, farms, factories . . . ). The people work together and use the products to keep the nation alive and healthy.

Ecosystem example: The basic building blocks of a forest are biosystems (trees, squirrels, wolves . . . ), ordisystems (ant colonies . . . ), and social systems (forest homes and communities . . . ), plus the products those systems need . . . which often include each other. Hence the tendency of members of an ecosystem to fight, subordinate, and kill each other to survive.

So a nation, though a complex nested system, can be perceived more simply and usefully (and still accurately) as the collective structures and activities of all of its basic building blocks—people and products.

### 4. Feeding the System

Living systems must absorb part of their environment to satisfy their structural and energy needs inside. Examples:

Biosystems: People and trees, as well as lions and rabbits and insects, eat food, drink water, and breathe air. These raw materials are ingested and used to satisfy the material and energy needs inside the biosystem.

Ordisystems: Honeybee hives consume nectar from flowers, which is used inside the colony to make honey.

Social systems: Nations consume natural resources (metals, timber, oil, ocean fish, water supplies, minerals in farmland, sunlight, wind power . . . . ). These raw materials are ingested and used to satisfy the material and energy needs inside the nation-that is, some of the resources are broken down into pieces that become part of the products and people in the nation, and some resources are converted to energy that gives motion, heat, light, and sound to the people and products.

So natural resources are the food of a social system.

Now we'll compare conventional economics with new economics made possible by the Vitality Ratio and its related classifications and definitions.

### 4. Definitions and Concepts

| | Vitality Ratio (New) | Conventional Economics |
|---|---|---|
| Basic | Tracks three very basic and clearly | Employs statistics and math for numerical analysis of |
| Economic | defined economic variables of society: | abstract and concrete economic forces in society such |
| Variables | people, products, and resources. | as interest rates, capital, labor, GDP, income, consumer |
| | | price index, corporate profits, return on equity, prime |
| | | rate, and opportunity cost. |
| What is a | A nation (or any other social system) | Although sometimes regarded as a group of people with |
| Nation | consists only of its basic building | common heritage and culture (as in the Jewish Nation |
| | blocks-the people who are directly | or the Cherokee Nation), a nation is more widely |
| | involved in the activities of the social | thought of as a nation-state - people living under one |
| | system, and all of the products they | government within territorial borders (as in the 192 |
| | use.* | members of the United Nations), along with their |
| | | personal and collective possessions and territorial |
| | | claims. By that definition, a nation would include |
| | | everything within the national borders, minus visiting |
| | | foreigners and foreign-owned property, plus citizens |
| | | traveling abroad, plus outside products that are owned |
| | | by the citizens and groups within the nation . . . |
| What are | Human beings taking part in the | In politics and law, “people” are generally citizens of a |
| people? | activities of a nation (or other social | recognized jurisdiction, as in “the People of Rome” or |
| | system). | the “People's Republic of China” or “The People vs. Joe |
| | | Smith.” |
| What are | Products are the substantive things | In business and marketing, a product is something that |
| products? | (energetic and material, living and non- | satisfies a want or need, sometimes called |
| | living) that people within a nation (or | “merchandise.” It can also include services such as |
| | social system) use, and which keep the | hours of maintenance. It also sometimes includes |
| | nation functioning in its internal and/or | symbols such as ID and serial numbers. |
| | external activities. | |
| What are | Natural resources are the “food” of | In traditional economics, natural resources were land, |
| natural | nations (and other social systems). They | labor, capital, and entrepreneurship. Today at least |
| resources? | are outside the social structure of people | three of those four things are called “factors of |
| | and products (not necessarily outside | production” rather than “natural resources,” and natural |
| | the territorial borders), and they are | resources are usually defined as raw materials in the |
| | useful and available to the system. Once | environment. Sometimes those raw materials are also |
| | consumed and put to use in the nation, | called “commodities,” although that term can also apply |
| | they become products, and they move | to products widely available in the open market. So in |
| | to the other side of the Vitality Ratio, | conventional economics the distinction between |
| | becoming part of the social system. | products and resources often become blurred. |
| What | A social system's needs are in line with | The system continues to grow, to use more resources, |
| makes | its resources (V = R:N) | to produce more products, and to show higher profits, |
| economies | | greater value, and more wealth, in perpetuity. |
| healthy? | | |

*This new definition of “nation” excludes ecosystems, biosystems, and ordisystems within the national borders that are not people or products. (It's up to law and politics to define territorial claims, borders, and citizenship criteria, and to decide which people, which products, and which resources are legal parts or possessions of a nation. Such abstract determinations are beyond the scope of the Vitality Ratio.)

As we can begin to see from the above comparisons, these new definitions and concepts can make a nation's economy much more manageable.

### 5. How the Vitality Ratio Works

The Vitality Ratio (V=R:N) simply means that the ratio between resources and needs is the main factor determining the economic vitality of a social system, just as the food that a biosystem eats is the main determining factor in the health of the biosystem. If there are enough appropriate resources to satisfy the needs of the social system (of people and products), then the system can be healthy. If there are shortages of appropriate resources, the well-being of the system begins to diminish.

The aim of the Vitality Ratio is simple: To provide on-going information about a social system's well-being (via a systemwide computer network) to allow the system (via its regulators) to sustain a balance between needs and resources. Generally speaking, throughout history there seems to be a tendency among nations toward ever-increasing needs (more people using more products), so maintaining a balanced ratio in the future will involve, in large part, finding ways to reduce needs and to increase resources in safe, healthy ways.

### 6. Via Nationwide Computer Network

Programming the Vitality Ratio into a nationwide computer network like the Internet would allow the monitoring the economic vitality of a nation. The elaborate, high-speed computer network will keep track of many variables in exhaustive detail, including:

A nation's needs: population and demographics, per-capita consumption of products, imports and exports, recycled products, product life expectancy, products in use, products in storage in warehouses, products on store shelves, products stored in homes and offices, nutritional qualities of consumable products, wholesome vs. unhealthy consumables vs. medicinal consumables etc. Eventually every home, office, and school will probably keep a running inventory of all products they acquire and use, but to begin with, the lowest level of reporting could be the retail merchants who sell products to families, offices, schools, and other end users. Most of them already keep sales figures and running inventories that could be plugged into the system.

A nation's resources: reserves of raw materials owned by the nation and its people, foreign raw materials accessible to the nation, renewable vs. nonrenewable resources, imports of foreign products, natural energy such as sunlight and wind, and more.

The computer program could be written in any of several computer programming languages, including C# (a popular, general-purpose language) or REBOL (a proprietary language designed specifically for network communications and distributed computing). The program that runs the Vitality Ratio tracks the many complex variables listed above; issues-alerts (emails, reports, printouts, etc.) whenever the needs for any resource exceeds its availability; runs algorithms while accessing its vast database of people, products, and resources to determine possible solutions; and outputs suggestions, in such forms as reports or emails or printouts, for remedial action. Said suggestions and remedial actions can be executed by the responsible regulatory agencies.

Adjusting said variables as needed in response to the Vitality Ratio alerts will help to ensure a balanced ratio, and that in turn will prevent or at least alleviate symptoms like those listed below.

### 7. Symptoms of a Low Ratio

When The Vitality Ratio goes negative—when needs exceed resources—various economic problems can develop, some simple and short-lived, others devastating and long-term. Symptoms of a negative ratio include:

Fewer products per capita. When needs for particular resources exceed supplies, there are fewer products made from those resources—fewer products to go around.

Rising prices. Carnivores during a drought fight more aggressively over a carcass, trees in a dense forest grow as tall as possible to compete for sunlight, and social systems facing a shortage of a particular resource pay more money to get it and its related products. Freezing or flooding or drought can ruin thousands of acres of raw farmland in any given year, resulting in shortages of wheat or rice or soybeans or oranges. Like the toughest carnivores and the tallest trees, the highest-paying social systems (processors, stores, consumers, etc.) get the goods. When resources (in this case, fertile farmland) are insufficient to satisfy needs, expensive products spread through society, and prices rise.

Inflation. As people and groups pay higher prices for the scarce resources and related goods, they demand more compensation for their own goods and services, and prices spiral upward.

Recession. As inflation spirals and things grow scarcer and get more and more expensive, it gets harder for social systems like companies to keep doing what they do, so things start to slow down. They cut jobs and maybe close their doors. This is recession, which often follows on the heels of unchecked inflation. Recession can usually be traced back in time through the inflation, to a negative ratio in which needs exceed resources. Recession is an unwitting effort by social systems to reduce their needs.

Depression. If recession doesn't adequately reduce needs, depression follows. As die unemployment lines grow and more commercial-industrial organs die within a nation, the surviving social subsystems and the nation as a whole begin to weaken dramatically, like an old man on his deathbed. As more businesses fold and the nation's physical structure continues to decay, products are being manufactured and distributed in inade-quate numbers. Resources may be growing plentiful, but the nation has no way to digest them, so they are not really resources anymore . . . just as food is no longer really food to a dying man. The nation is on the verge of depression. It is dying. Fortunately, nations are not biosystems. When nations “die” during a severe depression, they can rebuild.

The preceding symptoms of a low ratio are usually experienced by more advanced nations with a growth economy and can usually be traced back to needs outstripping resource availability. They could be alleviated, maybe eliminated, by The Vitality Ratio, which would raise a red flag as soon as needs begin to exceed resources, and a series of options (cutting back on particular products for awhile, finding replacement products or resources, or acquiring more resources from specific sources, for example) would be offered to help restore the balance.

The preceding symptoms are most debilitating to advanced nations whose infrastructures of people and products have grown fairly complex. Poor nations are not as vulnerable to sophisticated symptoms. Their needs are different. The usual cause of a low ratio in poor countries is overpopulation, and the following are among the most common symptoms:

Famine. Primitive cultures and other poorly integrated societies don't have a diversity of products. They need a steady supply of resources to feed the people, but only a modest amount to sustain the humble infrastructure. So, the usual cause of a severe resource shortage in a poor nation is overpopulation, and the chief symp-tom is famine. While the elaborate infrastructure of the advanced nation crumbles, poor nations are riddled by starvation and disease when their needs outstrip resources through overpopulation.

Mass execution. When resources are in serious short supply, envy and desperatio)n often lead to gross inhumanity. Mass execution is an unconscious, desperate effort by factions in a nation to solve economic problems by reducing needs. Just as a man whose family is starving might steal or even kill to feed them, a nation suffering a severe imbalance between resources and needs often vents its frustrations in cruel and unjust ways. The targeted victims of mass execution might constitute a group within society that is unwilling or unable to conform to national objectives or regulations for such reasons as religious belief, ignorance, intertribal contentions, or geographic isolation. Through mass execution some nations attempt to solve two problems-reduce needs and dissect an incompatible segment from the national structure.

Mass emigration. Occasionally there is an outpouring of people and products from a particular nation. Whether the group is exiled or feels pressured to flee for political or economic or religious reasons, it usually happens when the nation is suffering economic hardships—or, more specifically, when resources are in short supply. In the last half of the 20^{th} Century, Africa had 5 million homeless, 125,000 Cubans fled to America in a “freedom flotilla,” 800,000 Afghans fled to Pakistan, 500,000 Vietnamese fled to Thailand, tens of thousands of Jews fled from the Soviet Union, and hundreds of thousands of Mex-icans poured into the United States. When mass emigration occurs, needs are reduced in the nations left behind, and the receiving nations take on the economic strains of rising needs.

Those three economic syndromes of poor countries could also be alleviated (maybe eliminated) by The Vitality Ratio, whose aim, again, is to sustain a balance between needs and resources. In a country prone to overpopulation, needs would be kept in check largely by a multi-level family planning program like the one that transformed China from a peasant economy to an industrial leader in the closing decades of the Twentieth Century. A family-planning program, along with education (and, of course, an infrastructure of transportation, communication, and electricity), would be the backbone of The Vitality Ratio in poor countries.

The last two symptoms mentioned here, below, can afflict any nation, rich or poor, when its needs outstrip its resources.

War. Like mass execution, war is often a desperate attempt by a nation to bring needs into line with resources. It's often waged to steal resources from another country, such as oil in today's world. War also reduces needs by removing many people from the equation—military and civilian casualties.

Ecological destruction. When needs exceed resources, nations often become desperate enough to exploit the environment ruthlessly for more resources. When a nation becomes desperate, environmental concerns often take second seat to keeping the bloated structure well-fed, especially when leadership is weak or misguided. Land is ravag-ed, water and air are poisoned, and life cycles in the ecosystem are upset or devastated.

The Vitality Ratio would alleviate (maybe eliminate) war and environmental destruction along with the other symptoms by making sure needs did not exceed resources.

### 8. Two Main Causes of a Low Ratio in Today's World

Anything that causes the needs of a social system to increase (growing population or rising per-capita consumption, for example) and anything that causes the resource availability to decline (natural disasters, depletion of non-renewable resources, or resources lost by war, for example) can result in a low ratio in which needs exceed resource availability. Here we look at two of the leading causes today—uncontrolled population growth and growth economics.

Overpopulation. Of all the variables involved in needs and resources, none is as crucial as human population. Overpopulation has probably been the most pervasive negative ratio condition of humankind down through the ages, mostly because of high birthrate, but also resulting from such factors as mass immigration.

Experience around the world has revealed many devastating symptoms of overpopulation, including famine, war, environmental destruction, and mass execution. There will soon be 7 billion people on Earth, and devastating symptoms of unprecedented proportions are likely in many parts of the world unless we can get a handle on population growth very soon. The Vitality Ration could allow nations to do that.

Growth economics. While overpopulation is the main cause of a low ratio in poor countries, in some wealthy countries the main cause is high per-capita consumption and the growth economics that pushes it along. Modem economic thought is based on the belief that economic growth is the main measure of economic health and vitality, but it is an unnatural and dangerous belief. Unbridled growth in a biosystem is called cancer. Biosystems like the human body grow physically until they mature, then they sustain. That's what healthy societies would do. The always-grow-and-never-mature economic principle might have been important in the past in the drive to spread order out into the chaotic ecosystem by converting more and more land from ecosystem to social system, but today, as swelling nations push up against each other in the global ecosystem, the economics of growth breeds mistrust, conflict and inequity throughout most of the world.

So nations in the future will have to focus on economic sustainability (V=R:N) rather than economic growth. A balanced Vitality Ratio can ensure sustainability.

### 9. Obstacles to Overcome in Implementing The Vitality Ratio

There are some obstacles in the way of getting The Vitality Ratio working in today's world. First of all, there has to be a clear delineation between the social system (people and products) and the natural resources. Great care has to be taken in discerning products from resources. For example, a mushroom grown in a domestic greenhouse is a product. Growing wild it's a resource until it's processed, then it's a product. Grown in a foreign greenhouse it's a resource until it's imported, then it becomes a product. The status of every product and resource has to be tracked in detail. A natural analogy to this is how Vitamin D in the body can be either a hormone (if produced in the body) or a vitamin (if produced outside the body and ingested as a nutrient, as in a slice of cheese). The body's hormones are akin to a nation's products, and the body's vitamins are akin to a nation's resources. All quite natural . . . but somewhat complicated.

Another complication: Theoretically the Vitality Ratio can apply to any social system of any size, and that can get tricky. The natural resources of a family would include the things they buy at the store, and once those things are brought home and put away in the fridge or pantry, they're products. Those same things on the store shelves that are resources of the family, are actually products of the city and the nation where the family lives. So that's another complication in implementing the Vitality Ratio—coming to grips with the nested structure of life. These complications could be alleviated if we apply the Vitality Ratio only to nations, rather than to the smaller social systems that make up nations.

To implement the Vitality Ratio we would have to start with nations that are already integrated with a modern infrastructure—communication and transportation networks (especially a well-spread computer network); electricity, food and water readily available to everyone, and so on. We couldn't implement the Vitality Ratio in a primitive, nomadic society, for example.

Now, this is the most important obstacle: We can have only limited success trying to implement the Vitality Ratio in single nations. It can't be completely successful until it's implemented at the world level, bringing all nations into a single, integrated society of humankind. The reason is that people and products move fluidly among nations in the course of tourism, trade, and migration, making it nearly impossible to keep the “needs” variable steady. For example, one nation might implement the Vitality Ratio and keep its birthrate at a safe level, while other nations nearby let population grow out of control, compelling the crowds to overflow into the more stable nation, thus destabilizing it.

So the Vitality Ratio ultimately will have to be implemented at the planetary level, which will mean all nations will have to be fitted with modern communication, transportation, and energy infrastructures. Then, when all nations are up to speed, the global network will be implemented and monitored by many nations and corporations working together, probably through the United Nations.

Meanwhile, individual nations and blocs of contiguous nations could adopt the Vitality Ratio successfully if they are willing and able to control immigration very tightly.

### SUMMARY OF THE INVENTION

It can be seen from the above that an invention has been disclosed which fulfills all the objects of the invention. It is to be understood, however, that the disclosure is by way of description only, and that the scope of the invention is to be limited solely by the following claims:

I claim as my invention:

1. A ratio (V=R:N), which can be written into a program running on computers in a computer network such as the Internet, to assess a nation's economic vitality [V] by monitoring all of a nation's natural resource needs [N] (i.e. what is needed in terms of matter and energy to sustain the people and products which compose the nation) and the natural resources [R] available to satisfy those needs—said program then issuing alerts whenever the need for any particular resource exceeds its availability, and recommending remedial action.

2. The ratio of claim 1, which—along with associated classifications and definitions clearly described in this specification that make said ratio viable—can improve economic stability of nations and other social systems.

3. The ratio of claim 2, which can alleviate the severity of economic ailments that include inflation, recession, stagflation, depression, famine, mass execution, mass emigration, war, and environmental destruction.
